(19) United States
(12) Patent Application Publication
(10) Pub. No.: US 2024/0317429 A1
(43) Pub. Date: Sep. 26, 2024

(54) AUTOMATED AIRLINE MODULE SYSTEM BY WIRED ELECTRICAL ENERGY TRANSMITTED

(71) Applicant: CONG DIEN HOANG, Ho Chi Minh City (VN)

(72) Inventor: CONG DIEN HOANG, Ho Chi Minh City (VN)

(21) Appl. No.: 18/494,570

(22) Filed: Oct. 25, 2023

(30) Foreign Application Priority Data
Mar. 24, 2023 (VN) 1-2023-01966

(51) Int. Cl. B64U 50/34; B64U 10/20; B64U 50/19

(52) U.S. Cl. CPC B64U 50/34; B64U 10/20; B64U 50/19; B64U 2101/61

(57) ABSTRACT

The invention refers to an autonomous aviation module, equipped with one or multiple electrically powered propeller engines, capable of vertical take off and landing (VTOL), with electrical energy delivered through a system of wires along the device's flight path, employing autonomous flight technology and operated by a central control center.

### TECHNICAL FIELD

The invention relates to an autonomous aerospace module system using electrical energy transmitted through wires. Specifically, the module mentioned in the invention is applied in the aerospace field.

### BACKGROUND OF THE INVENTION

To transport people and vehicles over long distances or to overcome congested structures on the ground, there are currently several public transport systems such as:

Buses and electric buses: public transport systems that use fossil fuel or electric-powered vehicles to connect destinations in urban areas. Since they use the same infrastructure, that being the road systems, they are often severely affected by heavy traffic. If a dedicated bus lane (BRT) needs to be built, the cost of infrastructure construction will be high. Another feature is that these vehicles must carry their own energy source: fossil or hydro fuel tanks (buses) or rechargeable batteries (electric buses).

Electric ground vehicles (tram, trolley): similar to buses, these vehicles travel on the ground but with electric power supplied through the cable system. Therefore, they do not need to carry an energy source. The weakness of this system is that they share the road infrastructure in urban areas, so the speed is not high and they are easily congested. Most large cities in the world have now abandoned the use of this system.

Mass rapid transit (MRT), metro, subway, U-Bahn: large transportation systems used to transport passengers within an urban area, often running on rails. These routes are often located underground or elevated by a system of bridges. Since they do not use the same road infrastructure, they have high speed and large transportation volume. The main drawback is that they require dedicated routes: underground tunnels or bridges to overcome congestion points, thus the cost of infrastructure construction is very high.

Sky tram, cable car: systems that uses hanging supports to transport people through cabins moving along cables. They can overcome complex congestion points (mountains, hills, etc.). The main drawback is the high cost of construction and operation, while the loading capacity is small.

Ferry: a water transportation system with the ability to carry large loads at relatively low costs. It operates flexibly and can increase or decrease the number of ferries operating depending on traffic demand. The main limitation is that they are only used to overcome water obstacles (rivers, seas, etc.).

Transport aircraft (fixed-wing aircraft and helicopters): they can overcome long distances without relying on road infrastructure, with high speed and large load capacity. In large cities, high-rise buildings can be designed with helipads, forming a near-range air transport system in urban areas. However, they require large, complex infrastructure (airports). Aircraft must carry energy sources on board, so they consume a lot of energy when operating. On the other hand, controlling flying vehicles requires specific expertise such as pilots, so the cost of this system is very high, making it difficult to generate profits for short to medium distances.

Therefore, it is necessary to have a form of public transport with large load capacity, fast movement in urban environments, without using road systems, and requiring only minimal infrastructure.

### The Technical Nature of the Invention

The purpose of the invention is to propose a self-driving aerial module system for transporting people, goods, and land vehicles such as trucks, cars, and motorcycles. This system is designed to overcome congestion structures on the ground such as rivers, lakes, and road congestion points by flying over these structures. The purposes, advantages and other aspects of the invention will be clearer in the following detailed description with drawings.

### BRIEF DESCRIPTION OF DRAWINGS

FIG. 1a: Front view of module.

FIG. 1b: Side view of module.

FIG. 1c: Top view of module.

FIG. 2: Operation diagram of the connection system between the aviation module and the power transmission cable system.

### DETAILED DESCRIPTION OF THE INVENTION

The system consists of self-driving aerial modules and electricity transmission and control signal support towers. Specifically:

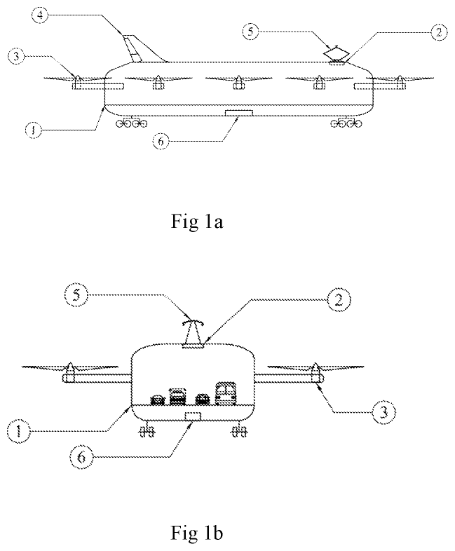

Reference to FIG. 1, the self-driving aerial module includes:

Module body (1): made of alloy and/or plastic, with a streamlined shape for good aerodynamics. There are doors that can open or lower down to allow vehicles to get on and off the module. Inside the module body is a space for storing the necessary interior fittings for people, goods, and vehicles that it carries.

Controller (2): The central processing unit (CPU) equipped in the module body operates the engines and wings automatically (autonomous flight technology), allowing the device to take off, fly, and land automatically and according control signals from the control center.

Engine (3): Equipped with electric fan engines attached on both sides of the module body (depending on the module size, it can be equipped with from one to ten engines) to help the module fly, take off and land vertically (VTOL).

Steering wing (4): Depending on the size and shape of the module, there are steering wings made of alloy and/or plastic, arranged on the body of the module, combined with engines to help the module fly, take off and land vertically (VTOL).

Pantograph (5): mounted on the module body (at the top or bottom of the module), connecting the module to the electric transmission cable and the control signal transmission cable from the control center. Through the pantograph, power and control signals are transmitted to the module for equipment operation.

Backup battery power supply module (6): placed within the module body, to provide backup power in case of power loss, allowing the module to self-control and safely land in an emergency situation.

The system of electric poles (7): carries power transmission cables and control signals:

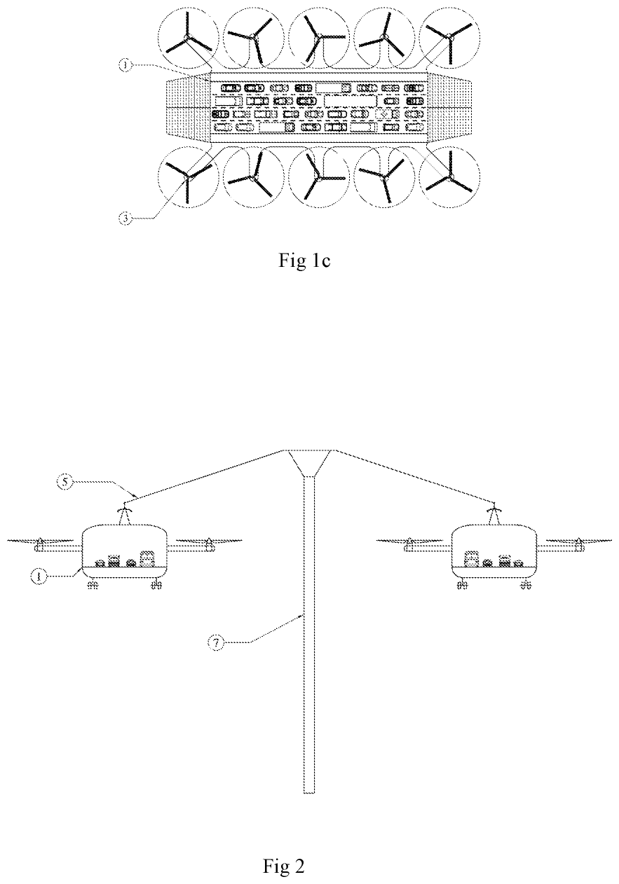

Reference to FIG. 2, the electrical tower system carries the transmission and control signals cables, at an approximately high altitude of unmanned aerial vehicles, arranged along their fixed flight path. They connect to the power source from the ordinary low-voltage electricity transmission network. Through the pantograph attached to the module body, the electrical power will be continually supplied to these airborne vehicles from the electricity transmission cable. This tower system also carries control signal cables from the control center to the aircraft modules at the same time.

New features of the autonomous aviation module compared to existing similar systems:
Using electric fan engine technology to create force for movement: stable, cost-effective, and available energy sources.
Vertical takeoff and landing (VTOL): no need for long runways at airports, only a landing area with an appropriate size for the module.
The system's movement speed is fast as it flies straight on the air route between the points, independent of the road routes, and unaffected by most construction works on the ground.
The electrical pole system's height is around 50-200 m with a fixed route following the transmission cable line designed to be appropriate for urban areas, without intersecting with current airline routes, thus not causing any safety issues for these airlines. Moreover, as it operates at a low altitude, this system does not comply with current international aviation regulations (applied to current transport aircraft). Therefore, it is necessary to establish regulations for low-altitude air traffic management to manage this system in the future.
The power transmission cable system draws electricity from the national low-voltage power grid, providing continuous power supply for the operation of the aviation module. The module itself does not have a main energy storage device, significantly reducing the load (compared to aircraft using conventional energy), therefore, it is possible to manufacture different types of modules with large and very large sizes and loads.
Using autonomous flight technology, operated under the control of the control center: there is no pilot crew to operate on the module; only manage, arrangement and customer service staff on the module.
The module system has high safety due to the use of self-balancing control technology for the flight module, and it only operates on a fixed and predetermined flight path. In case of power outage, the module be automatically control and carry out emergency landing at pre-determined safe points using the backup emergency battery installed on the module.
Despite the detailed description of its priority options, someone with average knowledge in this technical field needs to understand that various changes can be made without departing from the scope of the invention.

### Example of Invention Implementation

1. The emergency air transportation system connects hospitals in Ho Chi Minh City, Vietnam. It utilizes the rooftops of high-rise buildings in hospitals to build landing stations and constructs an electric cable network connecting these hospitals, forming a fast, safe, and efficient network for transporting patients by air between hospitals.
2. The airborne ferry system is implemented to resolve the congestion at Rach Mieu Bridge in Ben Tre Province, Vietnam. The bottleneck at Rach Mieu Bridge is addressed by using the airborne ferry system as a supplement to cross the Tien River.

1. An automated airline module system by wired electrical energy transmitted, in which an autonomous aviation module includes:
a module body: made of metal or plastic and aerodynamically shaped, with doors that open or lower for vehicles to climb onto the module, the module body contains a module storage compartment, which houses a set of interior equipment for passengers and cargo that the module carries;
at least one electric fan engine mounted on at least one side of the module body, allowing the autonomous aviation module to fly, take off and land vertically (VTOL);
a control system: equipped with a central processing unit (CPU) located within the module body that operates the at least one engine automatically (autonomous flight technology), allowing the autonomous aviation module to take off, fly and land automatically and according to control signals from a control center;
at least one steering wing: depending on the size and shape of the module body, the at least one steering wing is made of metal or plastic, located on the module body, and combined with the at least one engine helps the module fly, take off and land vertically (VTOL);
a pantograph attached to the module body either at a top or a bottom of the module, connecting the autonomous aviation module to an electric power transmission line and a control signal transmission line from the control center, Through the pantograph, electric power and control signals are transmitted to the module for equipment operation;
a backup battery placed inside the module body to provide backup power in case of a main power supply loss, enabling the module to be self-controlled and land safely in emergency situations.

2. The automated airline module system by wired electrical energy transmitted according to claim 1, in which:
the at least one electric fan engine receives a continuous supply of electric power through cables running along the device's flight path and uses autonomous flight technology;
the autonomous aviation module can be manufactured in various sizes, from a small air taxi module to a very large airborne ferry module capable of carrying a considerable load;
the autonomous aviation module operates automatically according to the control signals from the control center, so there is no pilot crew;
the system comprises plural autonomous aviation modules and electricity transmission and control signal support towers; and
systems of electric poles carrying power transmission cables and control signals.

3. The automated airline module system by wired electrical energy transmitted according to claim 1, wherein the module body comprises:
sufficient space to accommodate one emergency bed and from 04-06 people with emergency equipment system to operate as an emergency air transport module;
sufficient space to carry 04-10 seats with passengers and corresponding cargo to operate as an air taxi module;
sufficient space to carry 25-60 seats along with corresponding passengers and goods to operate as an air bus module;
sufficient space to carry 100 seats along with corresponding passengers and goods, 50 motorcycles and from 06-08 cars, trucks to operate as an air ferry module;
sufficient space to carry 600 seats with corresponding passengers and cargo, and 200 cars, trucks to operate as a large-scale air cargo ferry module.

4. The automated airline module system by wired electrical energy transmitted according to claim 1, wherein the module body comprises between 01-10 engines.
